(19) United States
(12) Patent Application Publication
(10) Pub. No.: US 2009/0125142 A1
(43) Pub. Date: May 14, 2009

(54) NUMERICALLY CONTROLLED GRINDING MACHINE AND PROCESS FOR CONTROLLING SAME

(75) Inventors: Peter Bauer, Herzogenaurach (DE); Andreas Uhlich, Wendelstein (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/300,910

(22) PCT Filed: Apr. 26, 2007
(86) PCT No.: PCT/EP2007/054114

§ 371 Date: Nov. 14, 2008

(30) Foreign Application Priority Data
May 16, 2006 (DE) 10 2006 022 831.6

(51) Int. Cl. G06F 19/00; B24B 51/00

(52) U.S. Cl. 700/164; 451/5

(57) ABSTRACT

The invention relates to a grinding machine in which the axis control command for the axis drive unit allocated to the axis is not calculated offline, and therefore beforehand outside of the grinding machine, as is common with the present state of technology, but rather online, in other words, in real time. A transformation model is provided to make this possible. Vectors with five components in the tool coordination system (WKS) can be converted into motion control commands (arrows 16,18,20,22,24) of the axis (X1,Z1,C1,B1,A1).

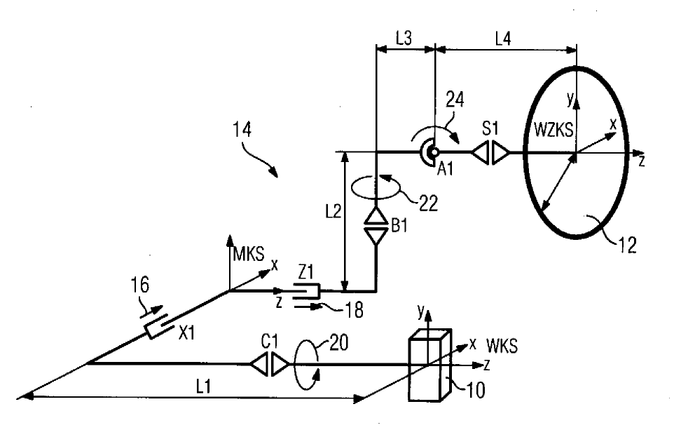

The invention relates to a method for controlling a (numerically controlled) grinding machine, particularly a cylindrical grinding machine having two linear axes and at least two further axes, differing from linear axes, during the machining of a workpiece. It also relates to a numerically controlled grinding machine on which the method can be carried out.

It is known from the field of milling machines that a numerical controller receives data relating to the desired surface contour of a workpiece to be machined, and converts said data into control commands for drive units that are assigned to the machine axes. This is simple in the case of milling machines because the latter usually have three linear axes that are mutually perpendicular, so that the Cartesian coordinates of the desired surface contour are converted directly into control commands.

This simple possibility does not arise in the case of grinding machines of the type mentioned at the beginning. The Cartesian coordinates of a desired surface contour of the workpiece cannot be used directly to produce control commands for axis drive units owing to the use of at least one axis differing from a linear axis in addition to two linear axes. Thus, it is customary in the prior art for the control commands to be produced offline, that is to say before the machining of the workpiece and outside the actual grinding machine or the data processing device thereof, for example with the aid of a CAD system (CAD meaning Computer Aided Design). Much flexibility is lost by the prior calculation of the axis control commands. Difficulties also arise in adapting the feeding on the axes (speed of the axes).

Said feeding must be adapted to the program instructions, and be defined. The prior calculation of the axis control commands also dictates restrictions with regard to data volume. Thus, it is a difficult matter in the prior art to carry out so-called interpolation movements, that is to say those movements in the case of which a number of axes execute movements coordinated in such a way that the tool travels along a predetermined contour line on the workpiece. In order to be able to define such contour lines, which can be straight lines or curved lines, at least approximately, the contour lines are divided into segments, and the axes are respectively driven such that the tool moves from the initial point of the segment to the end point of the segment, it being impossible for the path from the initial point to the end point to be set exactly. Improving the definition of the contours would entail an increase in the data volume in the case of the procedure according to the prior art.

The defective flexibility in the mode of procedure also results from the fact that the calculations are not based on a machine-independent model, but rather that the machine-specific properties of the grinding machine to be driven also need to be programmed in.

It is an object of the invention to provide for grinding machines, in particular cylindrical grinding machines, the possibility of producing desired surface contours of workpieces more precisely than heretofore by providing more precise axis control commands.

The object is achieved by means of a process according to patent claim 1 and a numerically controlled grinding machine according to patent claim 3.

The inventive process comprises the steps of:
producing a desired surface contour of the workpiece with the aid of a parts program,
deriving vectors with five parameters from the desired surface contour, of which three parameters correspond to positions of the desired surface in a Cartesian coordinate system and two parameters correspond to an orientation direction of the desired surface with regard to an orientation of the grinding wheel of the grinding machine,
feeding the vectors to a data processing device in the grinding machine,
calculating axis control commands for axis drive units of the grinding machine, assigned to the axes, from the vectors on the basis of a transformation model in the data processing device, doing so in real time while immediately
feeding the control commands to the axis drive units and implementing the axis control commands by means of the axis drive units.

The invention is based on the fact that the axis control commands are no longer produced in advance in an external CAD system, but rather in the numerically controlled grinding machine itself. It is also based on the fact that these calculations are performed in real time. These features ensure that large data volumes no longer arise as in the prior art. It is also thereby possible to travel on exact contour lines along the workpiece with the aid of the inventive process. Because of the real time calculation of the control commands, it is possible for virtually any coordinate point on the workpiece to be assigned an axis control command with the accuracy (granularity) enabled by the axis drive units, and so there is no longer any need to subdivide the contour lines to be traveled into segments.

The online calculation (real time calculation) of the axis control commands is enabled by the use of a transformation model. The latter also entails the advantage of greater flexibility overall. The transformation model can be used independently of details of the machine and need only be respectively parameterized from a specific machine. It is thus possible to provide for the data processing device in the grinding machine software to be loaded that includes the transformation model.

Even changes occurring in the short term in the kinematic parameters or in the kinematics itself can be compensated in the short term during the calculation.

Displacements and rotations are possible in the Cartesian coordinate system, which would generally be the workpiece coordinate system. If the workpiece cannot be clamped in the desired position, all that is required is to measure the displacement or rotation, and a correction can be performed in the calculation of the axis control commands. Such a procedure is impossible in the offline prior calculation of the prior art. It is also possible in the case of the invention to perform a correction flexibly as far as the shape of the tool is concerned. For example, it is possible to measure wear of the grinding wheel and take it into account in the online calculation. The online calculation with the aid of the transformation model adapts the axis control commands exactly to the contour at the Cartesian coordinate points for which the axis control commands are respectively calculated. There are thus no longer any problems in defining the speed (feed) in the case of the axis movement. Rather, it is equal to the “contour speed” during travel along the workpiece geometry. The invention also enables more complicated movements, particularly superposed movements of the various axes. An example of this is an oscillation of the tool along the line of contact with the workpiece.

In a preferred embodiment, the composition of the information from the vector is as follows: control commands for the two linear axes and a rotation axis of the grinding machine are derived from the three parameters, which correspond to the positions of the desired surface in the Cartesian coordinate system. Control commands for driving the grinding wheel can be calculated from the two parameters that correspond to the orientation direction of the desired surface and have therefore already been calculated in any case in advance for the control commands. These are usually the control commands for a further rotation axis and a pivot axis.

The inventive numerically controlled grinding machine having two linear axes, at least two axes differing from linear axes, axis drive units assigned to the axes, and having a data processing device is characterized in that the data processing device is designed for the purpose of using vector information fed to it relating to the desired surface contour of a workpiece in order to generate axis control commands for the axis drive units in real time, and of outputting them to the axis drive units.

The data processing device is preferably designed for said goal by providing a computer program. If the numerically controlled grinding machine has two linear axes, two rotation axes and a pivot axis, it is then possible for vectors having five parameters to be transformed on the basis of a transformation model into desired axis movements for the five axes. The axis control commands can then easily be derived from the desired axis movements.

The following description includes further details of the invention. It is given with reference to the drawing, the FIGURE schematically explaining the transformation model that is used in a preferred embodiment of the invention.

What is involved here is the machining of a workpiece 10 with the aid of a tool, more precisely a grinding wheel 12 in a cylindrical grinding machine denoted overall by 14. This workpiece has the workpiece coordinate system denoted by WKS. The cylindrical grinding machine has the machine coordinate system denoted by MKS, and the grinding wheel 12 can be assigned the tool coordinate system WZKS.

The machine comprises the following possibilities of movement: a linear axis X1 provides the possibility of movement along the x-axis of the machine coordinate system MKS, see arrow 16. A linear axis Z1 provides the possibility of movement along the z-axis of the machine coordinate system MKS, see arrow 18. A rotation axis C1 provides the possibility of rotation according to the arrow 20 about the z-axis. The grinding wheel 12 is fastened on a superstructure that enables a rotation by means of the rotation axis B1 in accordance with the arrow 22, and a pivoting in accordance with the arrow 24 on a pivot axis A1. The actual rotation of the grinding wheel is performed by means of the rotation axis S1. The FIGURE illustrates the lengths L1 to L4 that are included in the calculation within the scope of the model.

A desired surface contour of the workpiece 10 is designed with the aid of a parts program. This desired surface contour can now be used to derive vectors with five parameters. The vectors correspond to individual points on the desired surface. The first three parameters are the coordinates of the point in the workpiece coordinate system WKS corresponding to the x-axis, the y-axis and z-axis. Since the properties of the tool, in this case the grinding wheel 12, are also taken into account when producing the desired surface contour with the aid of the parts program, it is possible to define two further degrees of freedom of the desired surface contour that can later be assigned to the axes B1 and A1. This is denoted in the present application by the term “orientation direction”. Both degrees of freedom take account of the neighborhood of the point on the desired surface, in order to define how the point is to be machined with the aid of the grinding wheel 12. In mathematical terms, the two parameters can be two values of the derivation of the direction of the contour of the surface of the workpiece in two dimensions of the surface.

The movements of the axes X1, Z1 and C1 can be determined from the three first parameters of the vector. If the z-axis of the workpiece coordinate system WKS is covered by the z-axis of the machine coordinate system MKS, the z-coordinate can be transformed directly into a movement corresponding to the arrow 18. Because of the rotation corresponding to the arrow 10, using the basic axis C1, the y-coordinate also features in the calculation of the movement along the x-axis. In the case when the coordinate systems MKS and WKS do not cover one another, all three coordinates respectively feature in the movement of all three axes X1, Z1 and C1. The two parameters relating to the orientation direction of the desired surface in the vector can be transferred directly into control commands for the rotation axis B1 and the pivot axis A1. The decomposition of the vector into two parts, on the one hand the first three components that are assigned to the axes X1, Z1 and C1, and into the second components that are assigned to the axes B1 and A1, naturally constitutes the ideal case. Since the vector components, that is to say the five parameters of the vectors, correspond to five different degrees of freedom, it is also possible in principle to calculate the axis movements of said five axes from all five components in each case if this ideal case should not be obtained because of the mutual relationship of the coordinate systems MKS and WKS, or of the precise definition of the vectors.

1-4. (canceled)

5. A method for controlling a grinding machine having two linear axes and at least two additional axes different from the linear axes during a machining operation of a workpiece, comprising the steps of:
defining a desired surface contour of the workpiece with a parts program;
deriving from the desired surface contour vectors having five parameters, with three parameters corresponding to positions of the desired surface in a Cartesian coordinate system and two parameters corresponding to an orientation direction of the desired surface in relation to an orientation of a grinding wheel of the grinding machine;
supplying the vectors to a data processing device located in the grinding machine;
transforming the vectors in the data processing device in real time into axis control commands for axis drive units of the grinding machine assigned to the axes; and
immediately supplying the axis control commands to the axis drive units for controlling the grinding machine.

6. The method of claim 5, wherein the three parameters corresponding to positions of the desired surface comprise two linear axes and a first rotation axis, and the two parameters corresponding to the orientation direction of the desired surface comprise a second rotation axis and a pivot axis.

7. A numerically controlled grinding machine for machining a workpiece having two linear axes and at least two axes different from the linear axes, the grinding machine comprising:
drive units associated with the axes of the grinding machine; and
a data processing device comprising a parts program defining a desired surface contour of the workpiece; the data processing device configured to receive vectors relating to the desired surface contour of a workpiece and generating from the vectors axis control commands for the axis drive units in real time, and of outputting the axis control commands to the axis drive units.

8. The numerically controlled grinding machine of claim 7, wherein the axes that are different from the linear axes comprise two rotational axes and a pivot axis, the data processing device further comprising a computer program stored on a computer-readable medium, wherein the computer program when executed on the data processing device causes the data processing device to perform a transformation which transforms the vectors relating to the desired surface contour of the workpiece into the axis control commands for the axis drive units.
